(19) United States
(12) Patent Application Publication
(10) Pub. No.: US 2015/0047964 A1
(43) Pub. Date: Feb. 19, 2015

(54) DEVICE FOR SEPARATING OIL FROM AN OIL-WATER MIXTURE

(71) Applicant: KO-JEN HUANG, TAINAN CITY (TW)

(72) Inventor: KO-JEN HUANG, TAINAN CITY (TW)

(21) Appl. No.: 14/324,440

(22) Filed: Jul. 7, 2014

(30) Foreign Application Priority Data
Aug. 14, 2013 (TW) 102215249

(51) Int. Cl. B01D 3/10

(52) U.S. Cl. CPC B01D 3/106
USPC 202/205

(57) ABSTRACT

A device for separating oil from an oil-water mixture includes a first pump which is connected with a separation tank. The first pump pumps the oil-water mixture to the separation tank. A first valve is connected between the first pump and the separation tank. The separation tank has a heating unit and a cooler is connected to the top of the separation tank. The cooler is connected with a vacuum pump and a container. The oil is separated from the oil-water mixture effectively.

### BACKGROUND OF THE INVENTION

1. Fields of the Invention

The present invention relates to a device for separating oil from an oil-water mixture, and more particularly, to a high efficiency device for separating oil from an oil-water mixture.

2. Descriptions of Related Art

There are many oil-water mixtures used for lubricating and/or cleaning objects in industrial manufacturing processes. The similar oil-water mixture is also found in kitchen during processing or cooking dishes. Some of the oil is heated or worked under high temperature and pressure so that the oil cannot be used repeatedly and should be retrieved and applied with further treatments. The discarded oil pollutes the environment severely. However, because the oil in the oil-water mixture is difficult to be separated so that an effective method to separate the oil from an oil-water mixture is needed.

The conventional way is to scrub the oil layer from the top of the water, or to separate the oil from the water by eccentric force. Nevertheless, these conventional methods cannot completely separate the oil from the water, so that the water contains a certain amount of oil and the water is difficult to be re-used.

The present invention intends to provide a device for separating oil from an oil-water mixture so as to eliminate the shortcomings mentioned above.

### SUMMARY OF THE INVENTION

The present invention relates to a device for separating oil from an oil-water mixture, and comprises a first pump connected with a separation tank. A first valve is connected between the first pump and the separation tank. The separation tank has a heating unit. A cooler is connected to the top of the separation tank and the cooler is connected with a vacuum pump and a container.

Preferably, a storage tank is used to receive an oil-water mixture therein. The first pump is connected with the storage tank.

Preferably, a filtering unit is connected between the storage tank and the first pump.

Preferably, the separation tank has a level detection unit received therein.

Preferably, a second valve is connected between the separation tank and the cooler.

Preferably, the container is connected with a release valve.

Preferably, a second valve is connected to the underside of the separation tank and connected to the storage tank.

Preferably, a second valve is connected to the underside of the separation tank so as to release oil.

Preferably, the separation tank has an outlet valve connected to the underside thereof. The outlet valve is connected with an assistance cooling unit which is an elongate tank. The cooler is connected to the top of the assistance cooling unit. The assistance cooling unit is connected with the second pump which is connected to the storage tank.

Preferably, the separation tank has an outlet valve connected to the underside thereof. The outlet valve is connected with an assistance cooling unit which is an elongate tank. The cooler is connected to the top of the assistance cooling unit. The assistance cooling unit is connected with the second pump which releases the oil.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows the device for separating oil from an oil-water mixture of the of the present invention, and

FIG. 2 shows another embodiment of the device for separating oil from an oil-water mixture of the present invention.

### DETAILED DESCRIPTION OF THE PREFERRED EMBODIMENT

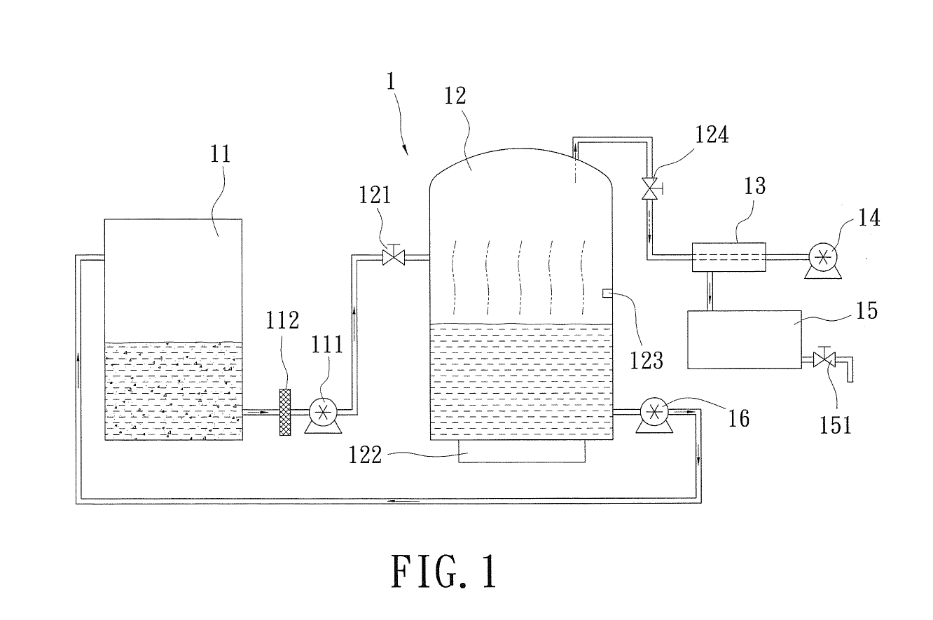

Referring to FIG. 1, a device 1 for separating oil from an oil-water mixture of the present invention comprises a storage tank 11 in which the oil-water mixture is received therein. A first pump 111 is connected with the storage tank 11. A filtering unit 112 is connected between the storage tank 11 and the first pump 111. The first pump 111 is connected with a separation tank 12. A first valve 121 is connected between the first pump 111 and the separation tank 12. The separation tank 12 has a heating unit 122. The separation tank 12 has a level detection unit 123 received therein. A cooler 13 is connected to the top of the separation tank 12. A second valve 124 is connected between the separation tank 12 and the cooler 13. The cooler 13 is connected with a vacuum pump 14 and a container 15. The container 15 is connected with a release valve 151. A second pump 16 is connected to the underside of the separation tank 12 and connected to the storage tank 11, or the second pump 16 releases oil to be proceeded with other treatments.

When in use, the first pump 111 pumps the oil-water mixture received in the storage tank 11 to the separation tank 12, and the debris in the oil-water mixture is filtered by the filtering unit 112. When the level of the oil-water mixture in the separation tank 12 reaches the pre-set level of the level detection unit 123, the first pump 111 stops and the first valve 121 is closed. The heating unit 122 heats the separation tank 12, and the vacuum pump 14 sucks the air in the separation tank 12 to form a vacuum environment to reduce the air pressure in the separation tank so that the boiling point of the oil-water mixture is reduced. The temperature of the oil-water mixture is increased along with the operation of the heating unit 122. Because the evaporation temperatures of the oil and the water are different so that the portion of the oil-water mixture with the lower boiling point is vaporized and the vapor is sucked by the vacuum pump 14 to the cooler 13. The vapor is cooled and condensed into liquid (oil or water) which is stored in the container 15, and the air is sucked out by the vacuum pump 14. The liquid in the container 15 can be released via the release valve 151 to achieve the purpose the separation of oil and water. The mixture that is left in the separation tank 12 is sent to the storage tank 11 by the second pump 16 to mix with the oil-water mixture in the storage tank 11, wherein the second valve 124 is shut off. The oil-water mixture in the storage tank 11 is then applied with the steps mentioned above to separate the oil from the water, or the mixture that is left in the separation tank 12 is released by the second pump 16.

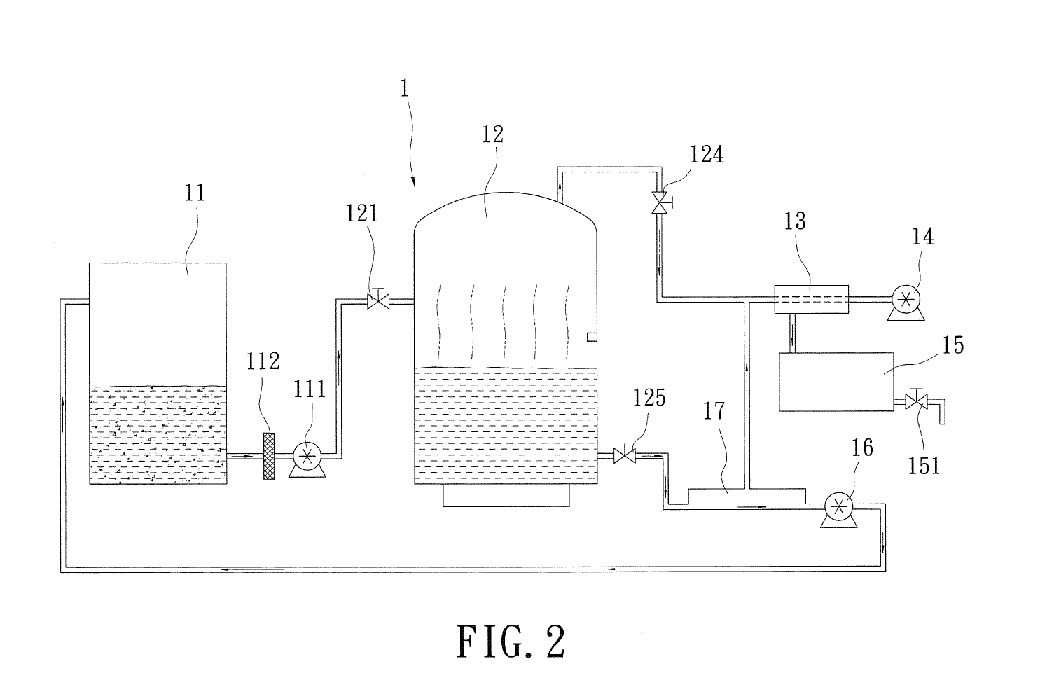

FIG. 2 shows the other embodiment of the present invention, wherein the separation tank 12 has an outlet valve 125 connected to the underside thereof. The outlet valve 125 is connected with an assistance cooling unit 17 which is an elongate and wide tank. The cooler 13 is connected to the top of the assistance cooling unit 17. The assistance cooling unit 17 is connected with the second pump 16 which releases the mixture that is left in the separation tank 12 via the outlet valve 125. Because the mixture that is left in the separation tank 12 has higher temperature, so that when the released mixture enters into the wide and elongate assistance cooling unit 17, the temperature of the mixture can be cooled quickly by the assistance cooling unit 17. The vapor generated during the cooling process rises and is cooled by the cooler 13. The vapor is condensed into liquid which flows into the container 15 to be stored.

The device 1 for separating oil from an oil-water mixture of the present invention effectively separates oil from water when compared with the conventional methods.

While we have shown and described the embodiment in accordance with the present invention, it should be clear to those skilled in the art that further embodiments may be made without departing from the scope of the present invention.

What is claimed is:

1. A device for separating oil from an oil-water mixture, comprising:
a first pump connected with a separation tank, a first valve connected between the first pump and the separation tank, the separation tank having a heating unit, a cooler connected to a top of the separation tank, the cooler connected with a vacuum pump and a container.

2. The device as claimed in claim 1 further comprising a storage tank which is adapted to receive an oil-water mixture therein, the first pump connected with the storage tank.

3. The device as claimed in claim 1, wherein a filtering unit is connected between the storage tank and the first pump.

4. The device as claimed in claim 1, wherein the separation tank has a level detection unit received therein

5. The device as claimed in claim 1, wherein a second valve is connected between the separation tank and the cooler.

6. The device as claimed in claim 1, wherein the container is connected with a release valve.

7. The device as claimed in claim 1, wherein a second pump is connected to an underside of the separation tank and connected to the storage tank.

8. The device as claimed in claim 1, wherein a second pump is connected to an underside of the separation tank and adapted to release oil.

9. The device as claimed in claim 1, wherein the separation tank has an outlet valve connected to an underside thereof, the outlet valve is connected with an assistance cooling unit which is an elongate tank, the cooler is connected to a top of the assistance cooling unit, the assistance cooling unit is connected with the second pump which is connected to the storage tank.

10. The device as claimed in claim 1, wherein the separation tank has an outlet valve connected to an underside thereof, the outlet valve is connected with an assistance cooling unit which is an elongate tank, the cooler is connected to a top of the assistance cooling unit, the assistance cooling unit is connected with the second pump which is adapted to release the oil.
